(19) United States
(12) Patent Application Publication
(10) Pub. No.: US 2024/0040662 A1
(43) Pub. Date: Feb. 1, 2024

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/478,762

(22) Filed: Sep. 29, 2023

Related U.S. Application Data
(63) Continuation of application No. PCT/JP2022/016093, filed on Mar. 30, 2022.
(60) Provisional application No. 63/167,818, filed on Mar. 30, 2021.

(51) Int. Cl. H04W 76/40; H04W 76/20

(52) U.S. Cl. CPC H04W 76/40; H04W 76/20

(57) ABSTRACT

A communication control method according to a first aspect is a method performed by a user equipment in a mobile communication system for providing a multicast broadcast service (MBS) from a base station to the user equipment. The communication control method includes receiving, from the base station, a PDCP packet encrypted by using a count value including a PDCP sequence number and a hyper frame number and transmitted in an MBS session; generating an inferred hyper frame number by inferring the hyper frame number; attempting decoding of the PDCP packet by using an inferred count value including the PDCP sequence number included in the PDCP packet received and the inferred hyper frame number; and determining the inferred hyper frame number as a valid hyper frame number when the decoding is successful.

### RELATED APPLICATIONS

The present application is a continuation based on PCT Application No. PCT/JP2022/016093, filed on Mar. 30, 2022, which claims the benefit of US Provisional Patent Application No. 63/167,818 filed on Mar. 30, 2021. The content of which is incorporated by reference herein in their entirety.

### TECHNICAL FIELD

The present disclosure relates to a communication control method and a user equipment used in a mobile communication system.

### BACKGROUND OF INVENTION

In recent years, a mobile communication system of the fifth generation (5G) has attracted attention. New Radio (NR), which is a Radio Access Technology (RAT) of the 5G system, has features such as high speed, large capacity, high reliability, and low latency compared to Long Term Evolution (LTE), which is a fourth-generation radio access technology.

### CITATION LIST

### Non-Patent Literature

Non-Patent Document 1: 3GPP Technical Specification “3GPP TS 38.300 V16.3.0 (2020 September)”

### SUMMARY

A communication control method according to a first aspect is a method performed by a user equipment in a mobile communication system for providing a multicast broadcast service (MBS) from a base station to the user equipment. The communication control method includes receiving, from the base station, a PDCP packet encrypted by using a count value including a PDCP sequence number and a hyper frame number and transmitted in an MBS session; generating an inferred hyper frame number by inferring the hyper frame number; attempting decoding of the PDCP packet by using an inferred count value including the PDCP sequence number included in the PDCP packet received and the inferred hyper frame number; and determining the inferred hyper frame number as a valid hyper frame number when the decoding is successful.

A communication control method according to a second aspect is a method performed by a user equipment in a mobile communication system for providing a multicast broadcast service (MBS) from a base station to the user equipment. The communication control method includes updating, by a PDCP entity of the user equipment in response to reception of a PDCP packet transmitted in an MBS session, a PDCP variable associated with the MBS session; and when the MBS session is interrupted, when the MBS session is resumed after the MBS session is interrupted, or when an instruction of initializing the PDCP variable is received from the base station, initializing the PDCP variable updated.

A communication control method according to a third aspect is a method performed by a user equipment in a mobile communication system for providing a multicast broadcast service (MBS) from a base station to the user equipment. The communication control method includes updating, by a PDCP entity of the user equipment in response to reception of a PDCP packet transmitted in an MBS session, a PDCP variable associated with the MBS session; when the PDCP entity is re-established, holding the PDCP variable associated with the MBS session without initializing the PDCP variable associated with the MBS session; and continuing, by the PDCP entity based on the PDCP variable held, processing of reception of the PDCP packet transmitted in the MBS session.

A communication control method according to a fourth aspect is a method performed by a user equipment in a mobile communication system for providing a multicast broadcast service (MBS) from a base station to the user equipment. The communication control method includes updating, by a PDCP entity of the user equipment in response to reception of a PDCP packet transmitted in an MBS session, a PDCP variable associated with the MBS session; and in advance of the user equipment performing handover, RRC re-establishment, or cell re-selection from a first cell to the second cell of the base station, receiving, from the base station, notification information indicating whether the PDCP variable updated is continuously usable in the second cell.

A communication control method according to a fifth aspect is a method performed by a user equipment in a mobile communication system for providing a multicast broadcast service (MBS) from a base station to the user equipment. The communication control method includes receiving, by an RLC entity of the user equipment from the base station, RLC PDUs transmitted in an MBS session and obtained by dividing an RLC SDU by the base station; and based on an RLC sequence number included in a first received RLC PDU of the RLC PDUs from the base station, determining whether to reconstruct the RLC SDU from the first received RLC PDU and an RLC PDU succeeding the first received RLC PDU.

A user equipment according to a sixth aspect includes a processor that executes the communication control method according to any one of the first to fifth aspects.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a correspondence relationship between a downlink Logical channel and a downlink Transport channel according to an embodiment.

FIG. 7 is a diagram illustrating a delivery method of MBS data according to an embodiment.

FIG. 8 is a diagram illustrating a split MBS bearer according to an embodiment.

FIG. 9 is a diagram illustrating an operation example related to activation and deactivation of a leg according to an embodiment.

FIG. 10 is a diagram illustrating Operation Example 1 of a PDCP according to an embodiment.

FIG. 11 is a diagram illustrating Operation Example 2 of the PDCP according to an embodiment.

FIG. 12 is a diagram illustrating Operation Example 3 of the PDCP according to an embodiment.

FIG. 13 is a diagram illustrating Operation Example 4 of the PDCP according to an embodiment.

FIG. 14 is a diagram illustrating Operation Example 5 of the PDCP according to an embodiment.

FIG. 15 is a diagram for illustrating Operation Example 6 of the PDCP according to an embodiment.

FIG. 16 is a diagram for illustrating an operation example of RLC according to an embodiment.

FIG. 17 is a diagram for illustrating an operation example of the RLC according to an embodiment.

FIG. 18 is a diagram for illustrating a case of reusing an existing PDCP functional view.

### DESCRIPTION OF EMBODIMENTS

Introduction of multicast broadcast services to the 5G system (NR) has been under study. NR multicast broadcast services are desired to provide enhanced services compared to LTE multicast broadcast services.

In view of this, the present disclosure provides a communication control method and a user equipment for implementing enhanced multicast broadcast services.

A mobile communication system according to an embodiment is described with reference to the drawings. In the description of the drawings, the same or similar parts are denoted by the same or similar reference signs.

### Configuration of Mobile Communication System

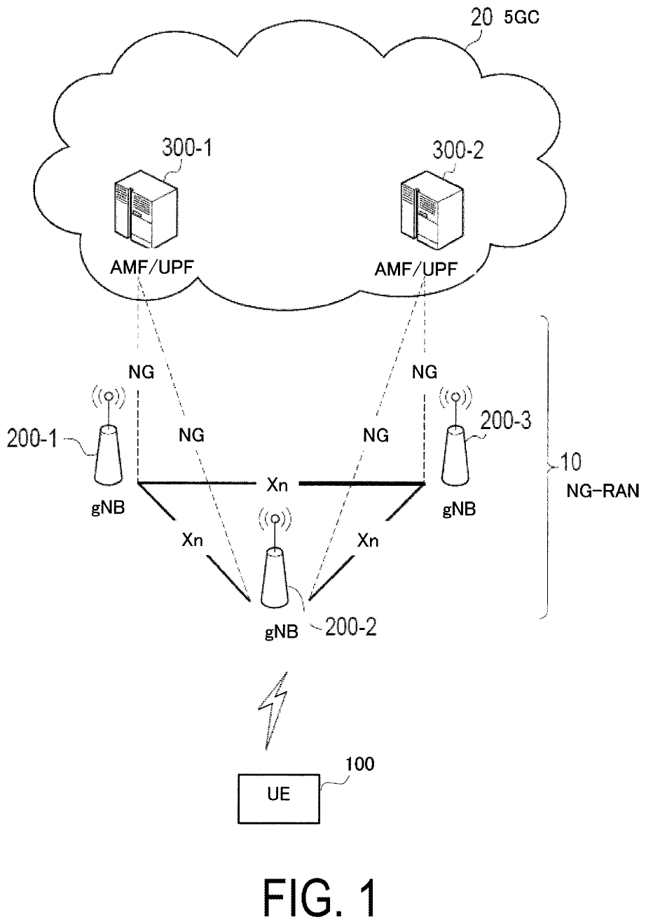

First, a configuration of a mobile communication system according to an embodiment is described. FIG. 1 is a diagram illustrating a configuration of the mobile communication system according to an embodiment. This mobile communication system complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

As illustrated in FIG. 1, the mobile communication system includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and/or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

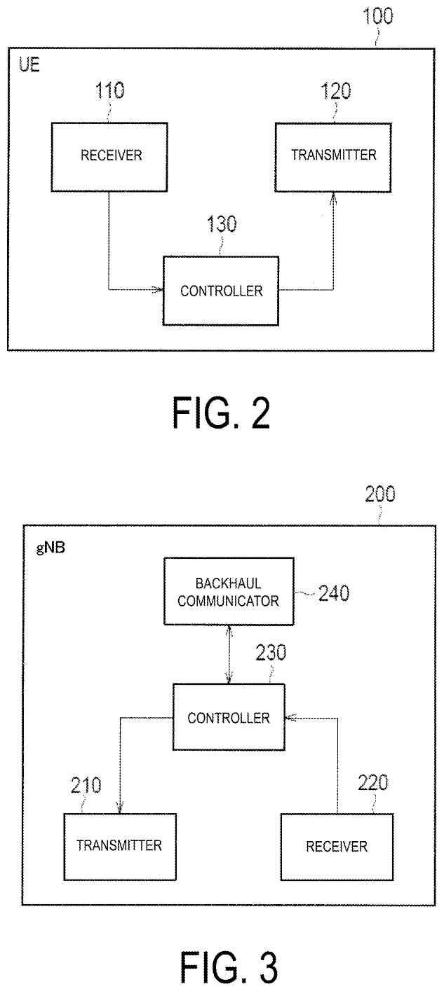

FIG. 2 is a diagram illustrating a configuration of the user equipment (UE) 100 according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

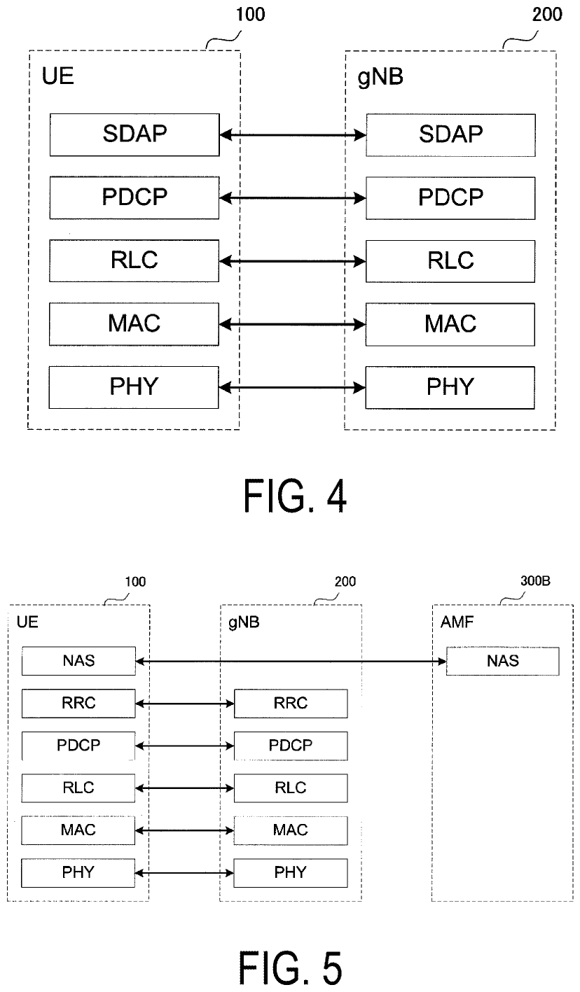

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300B.

Note that the UE 100 includes an application layer other than the protocol of the radio interface.

### MBS

An MBS according to an embodiment is described. The MBS is a service in which the NG-RAN 10 can provide broadcast or multicast, i.e., Point To Multipoint (PTM) data transmission to the UE 100. The MBS may be referred to as the Multimedia Broadcast and Multicast Service (MBMS). Note that use cases (service types) of the MBS include public safety communication, mission critical communication, Vehicle to Everything (V2X) communication, IPv4 or IPv6 multicast delivery, Internet protocol television (IPTV), group communication, and software delivery.

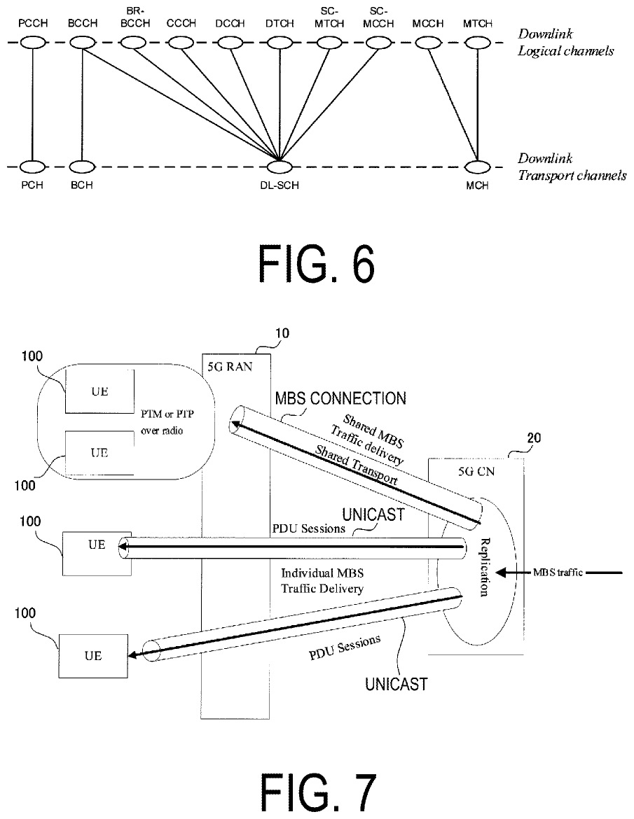

MBS Transmission in LTE includes two schemes, i.e., a Multicast Broadcast Single Frequency Network (MBSFN) transmission and Single Cell Point To Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH), and the transport channel used for SC-PTM transmission is a Downlink Shared Channel (DL-SCH). The SC-PTM transmission is primarily designed for single-cell transmission and corresponds to broadcast or multicast data transmission on a cell-by-cell basis. The physical channels used for SC-PTM transmission are a Physical Downlink Control Channel (PDCCH) and a Physical Downlink Shared Channel (PDSCH) and enable dynamic resource allocation.

Although an example will be mainly described below in which the MBS is provided using a scheme same as, and/or similar to, the SC-PTM transmission scheme, the MBS may be provided using the MBSFN transmission scheme. An example will be mainly described in which the MBS is provided using multicast. Accordingly, the MBS may be interpreted as multicast. Note that the MBS may be provided using broadcast.

MBS data refers to data provided by the MBS, an MBS control channel refers to the MCCH or SC-MCCH, and an MBS traffic channel refers to the MTCH or SC-MTCH. Note that the MBS data may be transmitted in unicast. The MBS data may be referred to as MBS packets or MBS traffic.

The network can provide different MBS services for respective MBS sessions. The MBS session is identified by at least one of Temporary Mobile Group Identity (TMGI) and a session identifier, and at least one of these identifiers is referred to as an MBS session identifier. Such an MBS session identifier may be referred to as an MBS service identifier or a multicast group identifier.

FIG. 7 is a diagram illustrating a delivery method of the MBS data according to an embodiment.

As illustrated in FIG. 7, the MBS data (MBS Traffic) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two delivery methods are possible: shared MBS data delivery (Shared MBS Traffic delivery) and individual MBS data delivery (Individual MBS Traffic delivery).

In the shared MBS data delivery, a connection is established between the NG-RAN 10 that is a 5G radio access network (5G RAN) and the 5GC 20 to deliver the MBS data from the 5GC 20 to the NG-RAN 10. Such a connection (a tunnel) is hereinafter referred to as an “MBS connection”.

The MBS connection may be referred to as a Shared MBS Traffic delivery connection or a shared transport. The MBS connection terminates at the NG-RAN 10 (i.e., the gNB 200). The MBS connection may correspond to an MBS session on a one-to-one basis.

The gNB 200 selects a transmission scheme either of Point-to-Point (PTP: unicast) or Point-to-Multipoint (PTM: multicast or broadcast) at the discretion of the gNB 200 and transmits the MBS data to the UE 100 through the selected transmission scheme.

On the other hand, in the individual MBS data delivery, a unicast session is established between the NG-RAN 10 and the UE 100 to individually deliver the MBS data from the 5GC 20 to the UE 100. Such unicast may be referred to as a PDU Session. The unicast (PDU session) terminates at the UE 100.

### Split MBS Bearer

A split MBS bearer according to an embodiment is described.

The gNB 200 may configure an MBS bearer split into a PTP communication path and a PTM communication path (hereinafter referred to as a “split MBS bearer” as appropriate) for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to enhance reliability.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

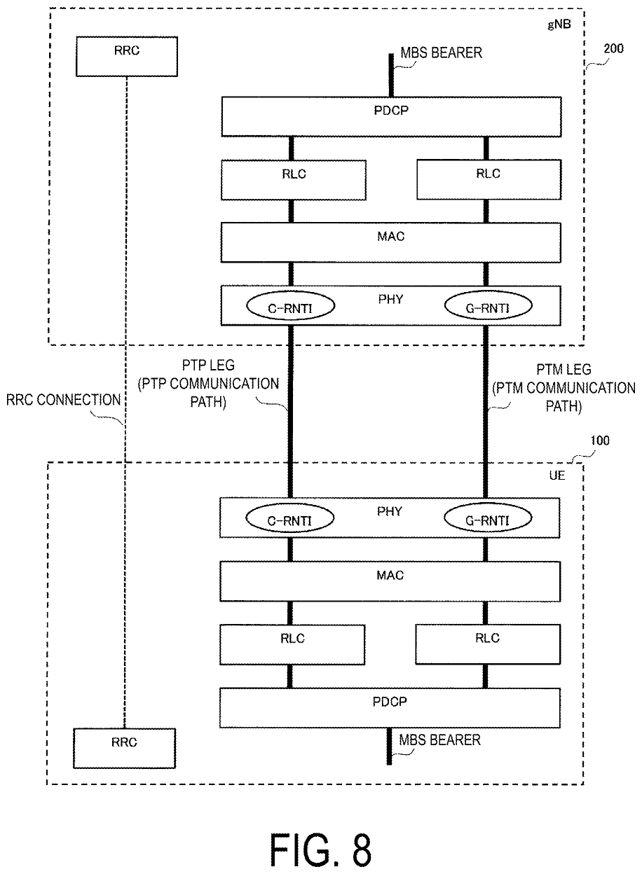

FIG. 8 is a diagram illustrating the split MBS bearer according to an embodiment. Hereinafter, the PTP communication path is referred to as a PTP leg, and the PTM communication path is referred to as a PTM leg. A functional unit corresponding to each layer is referred to as an entity.

As illustrated in FIG. 8, each of the PDCP entity of the gNB 200 and the PDCP entity of the UE 100 splits an MBS bearer, which is a bearer (data radio bearer) used for the MBS, into a PTP leg and a PTM leg. Note that the PDCP entity is provided for each bearer.

Each of the gNB 200 and the UE 100 includes two RLC entities provided for the respective legs, one MAC entity, and one PHY entity. The PHY entity may be provided per leg. Note that, in a Dual Connectivity in which the UE 100 communicates with two gNBs 200, the UE 100 may include two MAC entities.

The PHY entity transmits and receives data of the PTP leg using a cell RNTI (Cell Radio Network Temporary Identifier (C-RNTI)) that is allocated to the UE 100 on a one-to-one basis. The PHY entity transmits and receives data of the PTM leg using a group RNTI (Group Radio Network Temporary Identifier (G-RNTI)) allocated to the MBS session on a one-to-one basis. The C-RNTI is different for each UE 100, but the G-RNTI is an RNTI common to a plurality of UEs 100 receiving one MBS session.

In order to perform PTM transmission of the MBS data (multicast or broadcast) from the gNB 200 to the UE 100 using a PTM leg, a split MBS bearer needs to be configured for the UE 100 from the gNB 200 and the PTM leg needs to be activated. In other words, even if a split MBS bearer is configured for the UE 100, when a PTM leg is in a deactivation state, the gNB 200 cannot perform the PTM transmission of the MBS data using the PTM leg.

In order that the gNB 200 and the UE 100 perform PTP transmission of the MBS data (unicast) using a PTP leg, a split MBS bearer needs to be configured for the UE 100 from the gNB 200 and the PTP leg needs to be activated. In other words, even if a split MBS bearer is configured for the UE 100, when a PTP leg is in a deactivation state, the gNB 200 cannot perform the PTP transmission of the MBS data using the PTP leg.

When the PTM leg is in an activated state, the UE 100 monitors a Physical Downlink Control Channel (PDCCH) to which a G-RNTI associated with the MBS session is applied (i.e., performs blind decoding of the PDCCH using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the UE 100 monitors a PDCCH to which a C-RNTI is applied. When Discontinuous Reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission of other than the MBS data. Note that, when a cell (frequency) associated with an MBS session is specified, the UE 100 need not monitor a PDCCH for the MBS session.

Note that it is assumed that the above-described split MBS bearer is configured by use of an RRC message (for example, an RRC Reconfiguration message) transmitted by the RRC entity of the gNB 200 to the RRC entity of the UE 100.

### Activation and Deactivation of Leg

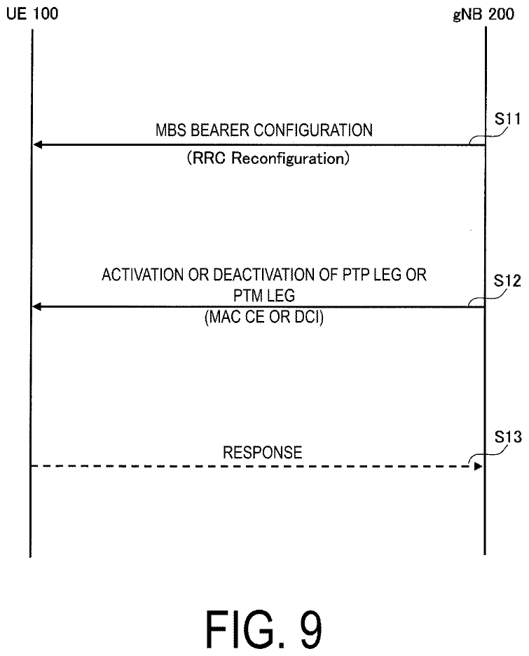

The activation and deactivation of a leg according to an embodiment is described. FIG. 9 is a diagram illustrating an operation example related to activation and deactivation of a leg according to an embodiment.

As illustrated in FIG. 9, in step S11, the RRC entity of the gNB 200 transmits to the UE 100 an RRC message including the configuration of the split MBS bearer (split bearer) illustrated in FIG. 8. The RRC message may be an RRC Reconfiguration message, for example. The RRC entity of the UE 100 establishes a split MBS bearer based on the configuration included in the RRC message received from the gNB 200. In the following, although an example in which one split MBS bearer is established by the UE 100 is mainly described below, the UE 100 may establish a plurality of split MBS bearers depending on the configuration from the gNB 200.

The gNB 200, when configuring a bearer by use of the RRC message (RRC Reconfiguration message), may indicate an initial state of each leg (that is, activation or deactivation of each leg) to the UE 100 by use of the same message. The RRC entity of the gNB 200, when transmitting the RRC message including the bearer configuration of the split MBS bearer to the UE 100, includes the indication of the activation or deactivation of each leg together with the bearer configuration in the RRC message.

Such an RRC message may include an identifier of a leg (a PTP leg or a PTM leg) to be indicated and/or an identifier indicating either of activation or deactivation. The RRC message may include an identifier (for example, a TMGI, a G-RNTI, a session identifier, a QoS flow identifier, or a bearer identifier) associated with the MBS session (split MBS bearer) to be indicated.

In step S12, the gNB 200 transmits to the UE 100 an indication of individually activating or deactivating the PTP leg and the PTM leg.

Here, the MAC entity of the gNB 200 may transmit a MAC control element (MAC CE) including the indication to the UE 100. The MAC entity of the UE 100 receives the MAC CE from gNB 200. Alternatively, the PHY entity of the gNB 200 may transmit downlink control information (DCI) including the indication to the UE 100. The PHY entity of the UE 100 receives the DCI from the gNB 200.

Such a MAC CE or DCI may include an identifier of a leg (a PTP leg or a PTM leg) to be indicated and/or an identifier indicating either of activation or deactivation. The MAC CE or the DCI may include an identifier (for example, a TMGI, a G-RNTI, a session identifier, a QoS flow identifier, or a bearer identifier) associated with the MBS session (split MBS bearer) to be indicated.

Indicating the activation and deactivation of each leg by use of the MAC CE or the DCI allows dynamic control compared with a case by use of the RRC message.

The UE 100, in response to receiving the indication of activating the PTP leg, starts data reception processing using the C-RNTI. The UE 100, in response to receiving the indication of activating the PTM leg, starts MBS data reception processing using the G-RNTI. On the other hand, the UE 100, in response to receiving the indication of deactivating the PTP leg, ends the data reception processing using the C-RNTI. The UE 100, in response to receiving the indication of deactivating the PTM leg, ends the MBS data reception processing using the G-RNTI.

In step S12, the gNB 200 may transmit an indication of activating or deactivating the PTP leg to the UE 100 via the PTM leg in the activated state (PTM transmission). This can collectively activate or deactivate the PTP legs of a plurality of UEs 100 via the PTM.

The gNB 200 may transmit an indication of deactivating the PTM leg to the UE 100 via the PTM leg in the activated state (PTM transmission). This can collectively deactivate the PTM legs of a plurality of UEs 100 via the PTM.

In step S12, the gNB 200 may transmit an indication of activating or deactivating the PTM leg to the UE 100 via the PTP leg in the activated state (PTP transmission). This can individually activate or deactivate the PTM leg for each UE 100.

The gNB 200 may transmit an indication of deactivating the PTP leg to the UE 100 via the PTP leg in the activated state (PTP transmission). This can individually deactivate the PTP leg for each UE 100.

In step S13, the UE 100, in response to receiving the indication of activating the PTP leg and/or the PTM leg from the gNB 200 in step S12, may transmit to the gNB 200 a response to the received indication. This response may be transmitted from the MAC entity of the UE 100 to the gNB 200 via the PTP leg, for example. The UE 100, after transmitting the response, may start a data reception operation on the activated leg.

The gNB 200, in response to receiving the response from the UE 100, transmits data via the activated leg. In other words, the gNB 200, after receiving the response, starts a data transmission operation on the leg.

Note that the UE 100, in response to receiving the indication of deactivating the PTP leg and/or the PTM leg from the gNB 200 in step S12, may transmit to the gNB 200 a response to the received indication.

When both the PTP leg and the PTM leg are activated, the PDCP entity of the UE 100 may perform a duplicate packet discarding process on two identical MBS packets transmitted through the Duplication transmission.

### Operation Example 1 of PDCP

Operation Example 1 of the PDCP according to an embodiment will be described.

The PDCP entity of the UE 100 configures and updates a PDCP variable in accordance with a PDCP sequence number (PDCP SN) included in a PDCP packet received from the gNB 200. Typically, the UE 100 configures the PDCP variable with an initial value of zero and updates (increments, counts up) the PDCP variable in response to receiving the packet from the gNB 200.

The PDCP entity of UE 100 participating in a certain MBS session from the beginning can sequentially update the PDCP variable to bring the PDCP variable to the latest state. On the other hand, the PDCP entity of the UE 100 participating in the MBS session halfway through may receive a PDCP packet having a PDCP SN of a value greatly different from the initial value and may thus fail to successfully perform the operation of the PDCP entity (predetermined PDCP operation).

In Operation Example 1, a method as described below enables the UE 100 participating in the MBS session halfway through to successfully perform the predetermined PDCP operation.

The PDCP entity of the UE 100 configures a PDCP SN included in the PDCP packet received first from the gNB 200 as an initial value of a variable (PDCP variable) to be used for the predetermined PDCP operation. Specifically, the PDCP entity of the UE 100, upon receiving the PDCP packet transmitted in an MBS session (PTM), does not configure the PDCP variable with a value of zero, but configures the PDCP SN included in the PDCP packet received first from the gNB 200 as the initial value of the PDCP variable. This allows the PDCP entity of the UE 100 participating in the MBS session halfway through to successfully perform the predetermined PDCP operation.

The predetermined PDCP operation is receive window control and/or a packet reordering operation.

A PDCP variable used for the reception window control may be RX_NEXT and/or RX_DELIV. RX_NEXT includes a sequence number of a PDCP SDU expected to be received next. RX_DELIV includes a sequence number of the oldest of the PDCP SDUs awaiting being received and not yet provided to the upper layer. Typically, initial values of RX_NEXT and RX_DELIV are “0”.

A PDCP variable used for the packet Reordering may be RX_REORD. RX_REORD is a sequence number of the PDCP SDU starting a timer indicating the maximum time to wait for the packet reordering. For example, when the sequence number of the received packet is smaller than RX_REORD, the UE 100 discards the packet.

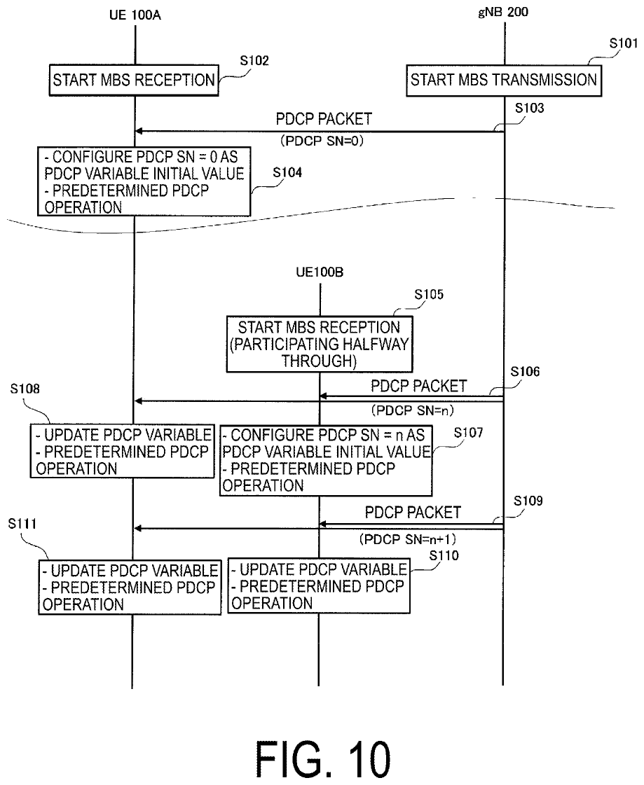

FIG. 10 is a diagram illustrating Operation Example 1 of the PDCP according to an embodiment.

As illustrated in FIG. 10, in step S101, the gNB 200 starts MBS transmission for a certain MBS session. In step S102, a UE 100A participating in the MBS session from the beginning starts MBS reception for the MBS session. The UE 100A is in the RRC connected state, the RRC idle state, or the RRC inactive state. The UE 100A may receive a configuration of the MBS bearer (PDCP) from the gNB 200 and perform the configuration.

In step S103, the gNB 200 transmits a PDCP packet via the MBS bearer using PTM. A sequence number (PDCP SN) included in the PDCP header of this PDCP packet is assumed to be “0”.

In step S104, the PDCP entity of the UE 100A, upon receiving the PDCP packet from the gNB 200, configures the PDCP SN “0” included in the received PDCP packet as an initial value of the PDCP variable and performs a predetermined PDCP operation.

After that, in step S105, a UE 100B participates in the MBS session halfway through and starts MBS reception for the MBS session. The UE 100B is in the RRC connected state, the RRC idle state, or the RRC inactive state. The UE 100B may receive a configuration of the MBS bearer (PDCP) from the gNB 200 and perform the configuration.

In step S106, the gNB 200 transmits a PDCP packet via the MBS bearer using PTM. A PDCP SN included in the PDCP header of this PDCP packet is assumed to be “n”. Here, “n” represents an integer of 1 or greater.

In step S107, the PDCP entity of the UE 100B, upon first receiving the PDCP packet via the MBS bearer, configures the PDCP SN “n” included in the first received PDCP packet as an initial value of the PDCP variable and performs a predetermined PDCP operation. For example, the PDCP entity of the UE 100B configures RX_DELIV=the sequence number “n” of the packet and RX_NEXT=the sequence number “n” of the packet. Alternatively, (n+1) mod [SN size] may be used.

In step S108, the PDCP entity of the UE 100A, upon receiving the PDCP packet via the MBS bearer, updates the PDCP variable with the PDCP SN “n” included in the received PDCP packet.

In step S109, the gNB 200 transmits a PDCP packet via the MBS bearer using PTM. A PDCP SN included in the PDCP header of this PDCP packet is assumed to be “n+1”.

In step S110, the PDCP entity of UE 100B, upon receiving the PDCP packet via the MBS bearer, updates the PDCP variable with the PDCP SN “n+1” included in the received PDCP packet.

In step S111, the PDCP entity of UE 100A, upon receiving the PDCP packet via the MBS bearer, updates the PDCP variable with the PDCP SN “n+1” included in the received PDCP packet.

In the present operation example, the initial value of each PDCP variable is updated from the received PDCP packet, but the operation is not limited to this. The initial value of each PDCP variable may be configured by the gNB 200 for the UE 100. For example, the UE 100B performing the MBS reception in the middle of the session may be given the initial value of each PDCP variable by the gNB 200, when the MBS reception is configured through dedicated signalling.

### Operation Example 2 of PDCP

Operation Example 2 of the PDCP according to an embodiment will be described focusing on differences from Operation Example 1 described above.

In Operation Example 1 described above, the PDCP SN is mainly assumed as the PDCP variable managed by the UE 100. In the present Operation Example 2, an example will be described in which the UE 100 also manages a hyper frame number (HFN) as a PDCP variable. The HFN is incremented when the PDCP SN wraps around. In other words, the HFN is a value that is counted up each time the PDCP SN wraps around.

For example, the UE 100 manages COUNT, which is a count value including a PDCP SN and an HFN. The format of RX_DELIV is the same as COUNT and is HFN+SN. COUNT is also used for encryption of PDCP packets for security.

In Operation Example 1 described above, the UE 100B participating in the MBS session halfway through calculates RX_DELIV from the PDCP SN included in the header of the PDCP packet (PDCP PDU) received first in this MBS session. Here, the header of the PDCP PDU includes the PDCP SN but no HFN.

The initial value of RX_DELIV is 0, and in the case of unicast, both gNB 200 and UE 100 increment the HFN for each wrap-around of the PDCP SN based on the initial value. This synchronizes the HFNs of gNB 200 and UE 100. On the other hand, in the case of multicast, which RX_DELIV the UE 100 starts to receive the PDCP packet at is uncertain as described above. Accordingly, a problem with multicast is that the valid HFN (that is, the HFN managed by the gNB 200) is not known even by looking at only the received PDCP packet.

In the present Operation Example 2, the PDCP entity of the UE 100 receives from the gNB 200 the PDCP packet that is encrypted using COUNT including the PDCP SN and the HFN and is transmitted in the MBS session. The PDCP entity of the UE 100 generates an inferred HFN by inferring the HFN. The PDCP entity of the UE 100 attempts decoding of the PDCP packet by using an inferred COUNT including the PDCP SN included in the received PDCP packet and the inferred HFN. When the decoding is successful, the PDCP entity of the UE 100 determines the inferred HFN as a valid HFN.

Thus, the UE 100 can derive a valid HFN by using the security function of the PDCP even when participating in the MBS session halfway through. Managing COUNT by using the HFN derived as described above allows PDCP variables such as RX_DELIV to be appropriately managed.

In the present Operation Example 2, the UE 100 may receive value range information indicating the value range of the HFN (hereinafter referred to as “HFN value range information”) from the gNB 200. The PDCP entity of the UE 100 may generate an inferred HFN based on the received HFN value range information. For example, the HFN included in the value range indicated by the received HFN value range information is generated as the inferred HFN. The decoding of the encrypted PDCP packet requires arithmetic processing, and thus the power consumption and response time of the UE 100 are problematic. In view of this, the gNB 200 notifies the UE 100 of the possible HFN in advance to decrease the number of candidates for the inferred HFN generated by the PDCP entity of the UE 100, allowing the power consumption and the response time of the UE 100 to be reduced.

Note that the gNB 200 may notify the UE 100 of the HFN value itself. However, the HFN is counted up according to the count-up of the PDCP SN. There may be a delay between the notification, by the gNB 200, of the current HFN to the UE 100 and the application of the HFN by the UE 100, and the HFN may be asynchronous between the gNB 200 and the UE 100.

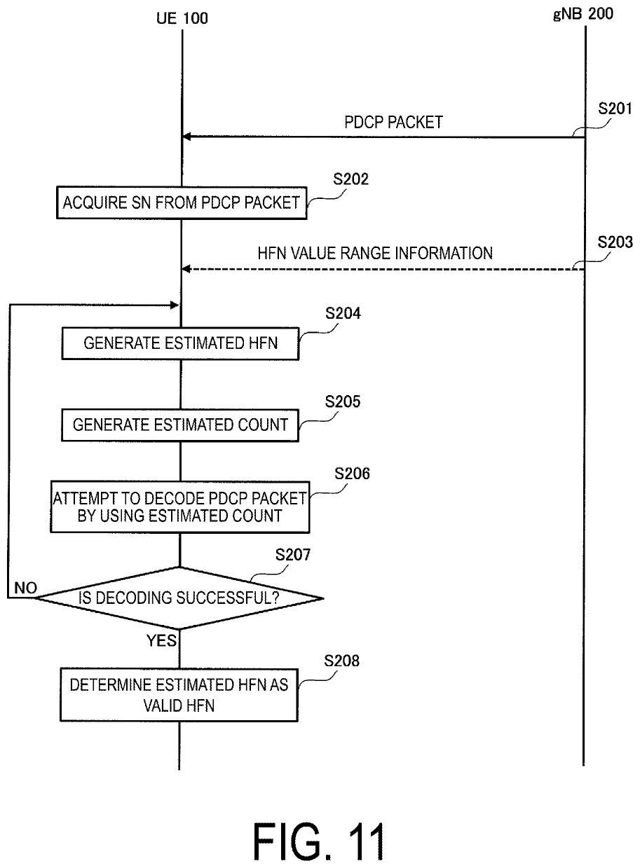

FIG. 11 is a diagram illustrating Operation Example 2 of the PDCP according to an embodiment. The UE 100 is assumed to be the UE 100B in Operation Example 1 described above, that is, the UE 100 participating in the MBS session halfway through.

As illustrated in FIG. 11, in step S201, the PDCP entity of the UE 100 receives a PDCP packet transmitted (for example, PTM transmission) from the gNB 200 in an MBS session.

In step S202, the PDCP entity of the UE 100 acquires a PDCP SN included in the header of the PDCP packet received in step S201. The value of the PDCP SN is assumed not to be zero because the UE 100 has participated in the MBS session halfway through.

In step S203, the UE 100 may receive HFN value range information from the gNB 200. The gNB 200 notifies a possible range (value range) of the HFN for a certain MBS session. The value range may be determined according to the amount of data transmitted using MBS, or the like. Note that step S203 may be performed before step S202.

The HFN value range information may be information directly indicating the value range (for example, “from 0 to 10”) of the HFN. The HFN value range information may be information indicating the number of bits (for example, “3 bits”: equivalent to “from 0 to 7”) of the HFN. When the HFN value range information is specified as “3 bits”, the PDCP entity of the UE 100 may manage the HFN in such a manner that “7” is followed by “0”.

The notification of the HFN value range information from the gNB 200 to the UE 100 may use an SIB, a multicast control channel (MCCH), an RRC Reconfiguration message, or a PDCP Control PDU. These messages may each include HFN value range information and an MBS session identifier (e.g., TMGI, G-RNTI) associated with the HFN value range information. These messages may each include a plurality of sets of HFN value range information and MBS session identifier.

In step S204, the PDCP entity of the UE 100 generates an inferred HFN. The PDCP entity of the UE 100 generates the inferred HFN by setting the HFN equal to values of 0, 1, 2, . . . , in order, for example. When the HFN value range information is received in step S203, the PDCP entity of the UE 100 generates an inferred HFN within the value range indicated by the HFN value range information.

In step S205, the PDCP entity of the UE 100 generates an inferred COUNT including the PDCP SN obtained in step S202 and the inferred HFN generated in step S204.

In step S206, the PDCP entity of the UE 100 attempts decoding (decryption) of the PDCP packet received in step S201 by using the inferred COUNT generated in step S205. If the decoding of the PDCP packet fails (step S207: NO), the processing returns to step S204.

If the decoding of the PDCP packet is successful (step S207: YES), in step S208, the PDCP entity of the UE 100 determines the inferred HFN generated in step S204 as a valid HFN, and stores and manages the HFN. Thus, the HFN is synchronized between the gNB 200 and the UE 100.

Note that, after the operation illustrated in FIG. 11, the UE 100 may perform handover from a first cell to a second cell of the gNB 200, RRC re-establishment, or cell re-selection. When the MBS session received by the UE 100 in the first cell is also provided in the second cell, the UE 100 can continue MBS reception even after the handover, RRC re-establishment, or cell re-selection performed. Note that the first cell and the second cell may be managed by different gNB s 200.

Here, in the first cell and the second cell, the PDCP SN may be synchronized between the cells, whereas the HFN may not be synchronized between the cells. Thus, the UE 100 may re-perform, in the second cell, an operation same as, and/or similar to, that in FIG. 11 on the basis of the handover from the first cell to the second cell, the RRC re-establishment, or the cell re-selection is performed.

The UE 100 may receive, from the gNB 200, information indicating whether the re-performing of the operation same as, and/or similar to, that in FIG. 11 is necessary, in advance of performing the handover from the first cell to the second cell, the RRC re-establishment, or the cell re-selection. When the information indicates that the re-performing is unnecessary, the managed HFN may be held, instead of being discarded, even after the handover from the first cell to the second cell, the RRC re-establishment, or the cell re-selection performed. Thus, when the HFN is synchronized between the first cell and the second cell, the UE 100 need not re-perform the operation same as, and/or similar to, that in FIG. 11. Details of such an operation will be described in Operation Example 6.

### Operation Example 3 of PDCP

Operation Example 3 of the PDCP according to an embodiment will be described focusing on differences from Operation Examples 1 and 2 described above.

As described above, since the HFN is counted up when the PDCP SN wraps around, there is no problem even when the PDCP SN wraps around. On the other hand, the HFN is not assumed to wrap around (that is, the COUNT does not wrap around). Accordingly, the PDCP variable (e.g., COUNT) including the HFN is desirable to be able to be initialized when the HFN is about to wrap around.

In Operation Example 3, in response to receiving the PDCP packet transmitted in an MBS session, the PDCP entity of the UE 100 updates the PDCP variable associated with the MBS session. The PDCP entity of the UE 100 initializes (i.e., returns to zero) the updated PDCP variable when the MBS session is resumed after the MBS session is interrupted. As described above, in Operation Example 3, the PDCP entity of the UE 100 initializes the PDCP variable by using resumption of the MBS session as a trigger. Thus, for example, when the HFN is about to wrap around, the PDCP variable (e.g., COUNT) including the HFN can be initialized.

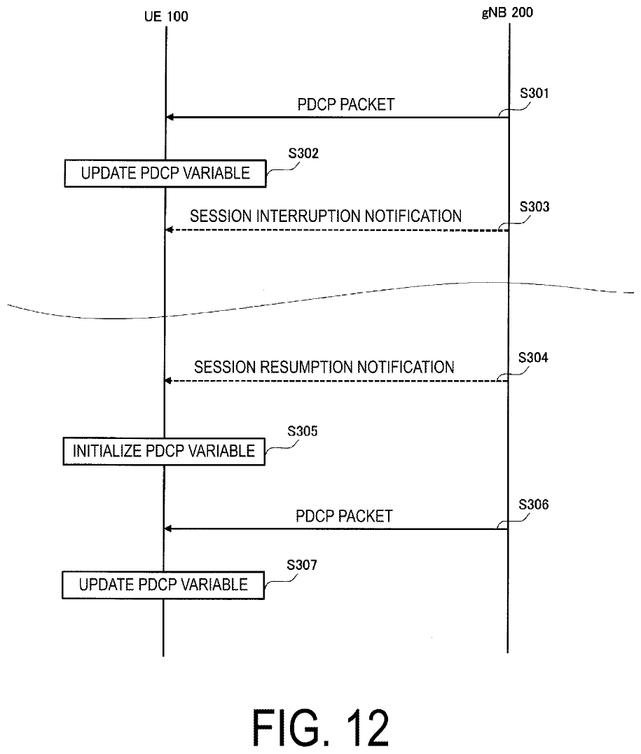

FIG. 12 is a diagram illustrating Operation Example 3 of the PDCP according to an embodiment. The UE 100 may be a UE 100 participating in an MBS session from the beginning. The UE 100 may be a UE 100 participating in an MBS session halfway through. The gNB 200 may transmit MBS data to a plurality of the UEs 100 in the RRC connected state using multicast.

As illustrated in FIG. 12, in step S301, the PDCP entity of the UE 100 receives a PDCP packet transmitted (for example, PTM transmission) from the gNB 200 in an MBS session.

In step S302, the PDCP entity of the UE 100 updates the PDCP variable (e.g., COUNT), based on the PDCP packet received in step S301. The PDCP variable to be updated may be RX_NEXT and/or RX_DELIV.

In step S303, the gNB 200 may transmit, to the UE 100, a session interruption notification indicating interruption of the MBS session. The session interruption notification may be transmitted in the MAC CE. The session interruption notification may be transmitted through the SIB, multicast control channel (MCCH), RRC Reconfiguration message, or PDCP Control PDU. The UE 100 detects the interruption of the MBS session in response to receiving the session interruption notification. Alternatively, the UE 100 may determine that the MBS session is interrupted when the UE 100 does not receive MBS data in the MBS session for a certain period of time, regardless of the session interruption notification. A timer value defining the certain period of time may be configured by the gNB 200 for the UE 100, for example. The gNB 200 may configure a set of the timer value and an MBS session identifier (e.g., TMGI, G-RNTI) for the UE 100.

After that, in step S304, the gNB 200 may transmit, to the UE 100, a session resumption notification indicating resumption of the MBS session. The session resumption notification may be transmitted in the MAC CE. The session resumption notification may be transmitted through the SIB, multicast control channel (MCCH), RRC Reconfiguration message, or PDCP Control PDU. The UE 100 detects resumption of the MBS session in response to receiving the session resumption notification. Alternatively, the UE 100 may determine that the MBS session is resumed when the MBS data is received in the MBS session after determination of the interrupted MBS session, regardless of the session resumption notification.

In step S305, when the MBS session is resumed after the MBS session is interrupted, the PDCP entity of the UE 100 initializes (i.e., returns to zero) the updated PDCP variable associated with the MBS session. Similarly, the gNB 200 may initialize the updated PDCP variable associated with the MBS session.

In step S306, the PDCP entity of the UE 100 receives a PDCP packet transmitted from the gNB 200 in the MBS session.

In step S307, the PDCP entity of the UE 100 updates the PDCP variable (e.g., COUNT), based on the PDCP packet received in step S306.

In the present Operation Example 3, the UE 100 may initialize the PDCP variable when detecting interruption of the MBS session in step S303.

In the present Operation Example 3, upon detecting interruption of the MBS session in step S303 or detecting resumption of the MBS session in step S304, the UE 100 may re-establish the PDCP entity in step S305. In the UE 100, the RRC layer may indicate the re-establishment of the PDCP entity to the PDCP layer. Re-establishment of the PDCP entity causes the PDCP variable managed by the PDCP entity to be initialized.

### Operation Example 4 of PDCP

Operation Example 4 of the PDCP according to an embodiment will be described focusing on differences from Operation Examples 1 to 3 described above.

In Operation Example 3 described above, an example has been described in which the UE 100 autonomously initializes the PDCP variable. On the other hand, in the present Operation Example 4, the UE 100 initializes the PDCP variable in accordance with reception of an instruction from the gNB 200.

For example, with a plurality of the UEs 100 receiving MBS data for a certain MBS session from the gNB 200 by using multicast, one of the plurality of the UEs 100 is assumed to perform handover or RRC re-establishment. Normally, the PDCP entity of the UE 100 is re-established in connection with the handover or RRC re-establishment by the UE 100, and thus the PDCP variable managed by the PDCP entity is to be initialized. Alternatively, as described in PDCP Operation Example 3 described above, before COUNT of the MBS session reaches the upper limit (i.e., when wrap around is about to occur), the PDCP variables of one or more UEs receiving the MBS session need to be initialized.

In the present Operation Example 4, the PDCP entity of the UE 100 updates the PDCP variable associated with the MBS session in response to receiving the PDCP packet transmitted in the MBS session. The PDCP entity of the UE 100 initializes (i.e., returns to zero) the updated PDCP variable when receiving, from the gNB 200, an instruction for initializing the PDCP variable. Thus, for example, when the HFN is about to wrap around, the PDCP variable (e.g., COUNT) including the HFN can be initialized. Note that as described above, re-establishment of the PDCP entity causes the PDCP variable to be initialized, and thus that the instruction for initializing the PDCP variable may be an instruction for re-establishing the PDCP entity.

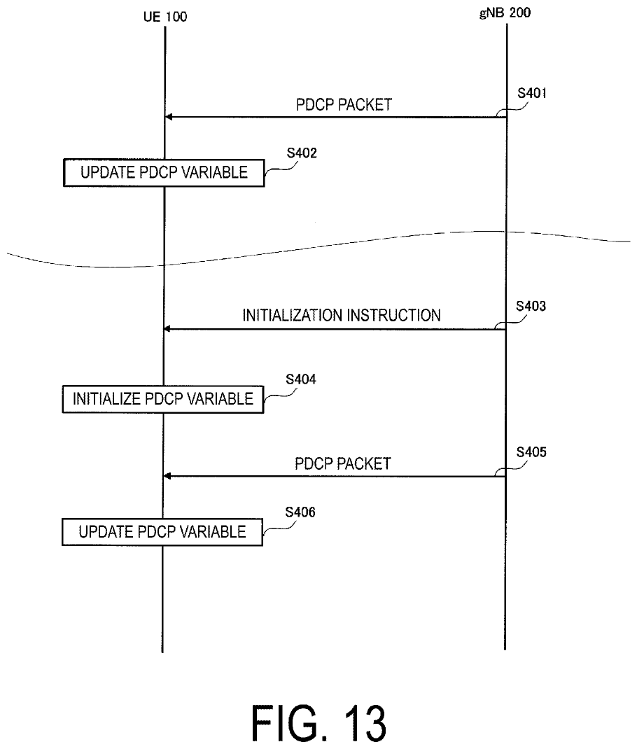

FIG. 13 is a diagram illustrating Operation Example 4 of the PDCP according to an embodiment. The UE 100 may be a UE 100 participating in an MBS session from the beginning. The UE 100 may be a UE 100 participating in an MBS session halfway through. The gNB 200 may transmit MBS data to a plurality of the UEs 100 in the RRC connected state using multicast. The gNB 200 may transmit MBS data to a plurality of the UEs 100 in the RRC idle or inactive state using multicast.

As illustrated in FIG. 13, in step S401, the PDCP entity of the UE 100 receives a PDCP packet transmitted (for example, PTM transmission) from the gNB 200 in an MBS session.

In step S402, the PDCP entity of the UE 100 updates the PDCP variable (e.g., COUNT), based on the PDCP packet received in step S401. The PDCP variable to be updated may be RX_NEXT and/or RX_DELIV. Similarly, the PDCP entity of the gNB 200 updates the PDCP variable (e.g., COUNT), based on the packet transmitted in step S401.

After that, in step S403, the gNB 200 transmits, to the UE 100, an initialization instruction for instructing the initialization of the PDCP variable. As described above, the initialization instruction may be an instruction for re-establishing the PDCP entity. The gNB 200 may stop (suspend) the transmission of the PDCP packet before transmitting the initialization instruction. The gNB 200 may transmit the initialization instruction in response to the PDCP variable of the PDCP entity of the gNB 200 being about to wrap around (for example, reaching the COUNT upper limit value). The initialization instruction may be transmitted through an RRC Reconfiguration message, a PDCP Control PDU, the SIB, or the multicast control channel (MCCH). The initialization instruction may be transmitted on a MAC Control Element (CE) or a multicast traffic channel (MTCH). Note that the initialization instruction is desirably notified to a plurality of the UEs at the same time. For example, for the notification, the MAC CE indicating the initialization instruction may be multiplexed with the transport block including the MTCH for multicast. These messages may each include the initialization instruction and an MBS session identifier (e.g., TMGI, G-RNTI, session ID) associated with the initialization instruction. In addition to or instead of the MBS session identifier, a bearer ID (or an MBS bearer ID) may be used.

Note that the gNB 200 may transmit the initialization instruction in step S403 in response to a different UE 100 having re-established the PDCP entity, the different UE 100 receiving the same MBS session as the above-described UE 100 using multicast, that is, in response to the different UE 100 having initialized the PDCP variable. Thus, a plurality of UEs 100 receiving the same MBS session all initializes the PDCP variable.

In step S404, the PDCP entity of the UE 100 initializes (i.e., returns to zero) the updated PDCP variable associated with the MBS session in response to receiving the initialization instruction in step S403. Similarly, the gNB 200 may initialize the updated PDCP variable associated with the MBS session. The initialization of the PDCP variable may be performed in the re-establishment of the PDCP entity.

In step S405, the PDCP entity of the UE 100 receives a PDCP packet transmitted from the gNB 200 in the MBS session. The gNB 200 may resume the transmission of the PDCP packet in response to completion of initialization of the PDCP variables of all the UEs that receive multicast.

In step S406, the PDCP entity of the UE 100 updates the PDCP variable (e.g., COUNT), based on the PDCP packet received in step S406.

Note that, also in Operation Example 3 described above, when one of a plurality of UEs 100 receiving the same MBS session re-establishes the PDCP entity, another UE 100 of the plurality of UEs 100 may operate to initialize the PDCP variable as in Operation Example 4. For example, when one of a plurality of UEs 100 receiving the same MBS session re-establishes the PDCP entity, the gNB 200 100 interrupts the MBS session and then resumes the MBS session. Thus, a plurality of UEs 100 receiving the same MBS session all initializes the PDCP variable.

### Operation Example 5 of PDCP

Operation Example 5 of the PDCP according to an embodiment will be described focusing on differences from Operation Examples 1 to 4 described above.

In Operation Example 4 described above, an example has been described in which, when the UE 100 has re-established the PDCP entity, the UE 100 initializes the PDCP variable. In this case, as described above, another UE 100 receiving the same MBS session using multicast may also need to initialize the PDCP variable. In other words, re-establishment of the PDCP entity in one UE 100 receiving the same MBS session using multicast may adversely affect another UE 100.

Accordingly, in the present Operation Example 5, for the PDCP for the MBS session (MBS bearer), even when the PDCP entity is re-established, the PDCP variable is not initialized and the PDCP variable used before the re-establishment is continuously used. In other words, the PDCP entity of the UE 100 updates the PDCP variable associated with the MBS session in response to receiving the PDCP packet transmitted in the MBS session. When the PDCP entity is re-established, the UE 100 holds the PDCP variable associated with the MBS session without initializing the PDCP variable. The PDCP entity of the UE 100 continues the reception processing (PDCP operation) for the PDCP packet transmitted in the MBS session, based on the held PDCP variable. This can suppress re-establishment of the PDCP entity in one UE 100 receiving the same MBS session using multicast from adversely affecting another UE 100.

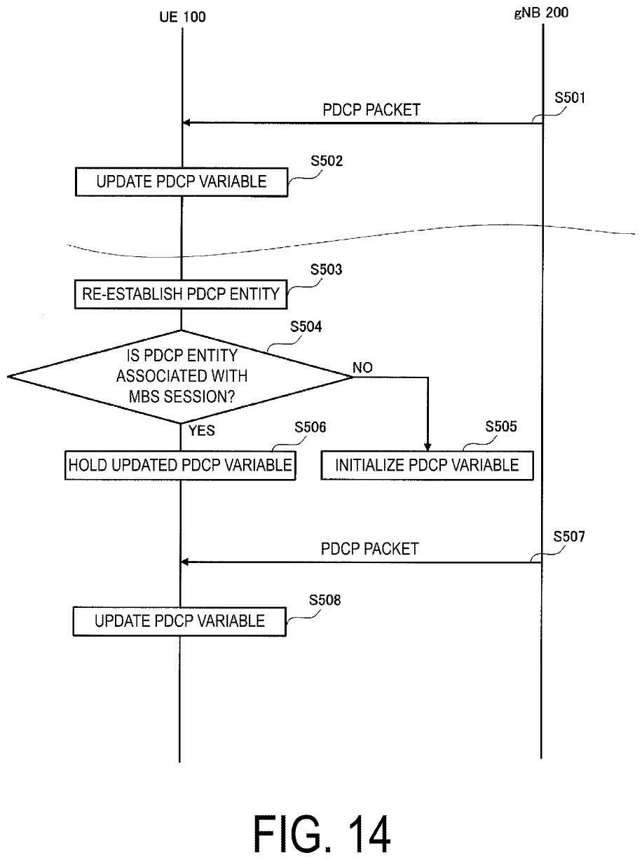

FIG. 14 is a diagram illustrating Operation Example 5 of the PDCP according to an embodiment. The UE 100 may be a UE 100 participating in an MBS session from the beginning. The UE 100 may be a UE 100 participating in an MBS session halfway through. The gNB 200 may transmit MBS data to a plurality of the UEs 100 in the RRC connected state using multicast.

As illustrated in FIG. 14, in step S501, the PDCP entity of the UE 100 receives a PDCP packet transmitted (for example, PTM transmission) from the gNB 200 in an MBS session.

In step S502, the PDCP entity of the UE 100 updates the PDCP variable (e.g., COUNT), based on the PDCP packet received in step S401. The PDCP variable to be updated may be RX_NEXT and/or RX_DELIV.

In step S503, the UE 100 re-establishes the PDCP entity in connection with handover or RRC re-establishment. In other words, the UE 100 deletes the old PDCP entity used before performing the handover or RRC re-establishment and generates a new PDCP entity. Note that, it is assumed that the PDCP variable updated by the old PDCP entity can be held in a predetermined storage area. Note that the UE 100 may receive, from the gNB 200, the re-establishment instruction for instructing the re-establishment of the PDCP entity and re-establish the PDCP entity in response to reception of the re-establishment instruction.

In step S504, the UE 100 determines whether the PDCP entity involved in the re-establishment is associated with the MBS session. The UE 100 may determine whether the PDCP entity involved in the re-establishment is configured to hold the PDCP variable without initializing the PDCP variable. Such configuration may be performed, for example, for the UE 100 by the gNB 200 through an RRC Reconfiguration message. When the UE 100 receives, from the gNB 200, the re-establishment instruction for instructing the re-establishment of the PDCP entity, the UE 100 may determine whether the re-establishment instruction includes information indicating that the PDCP variable is held without being initialized (for example, “COUNT−continued=true”). When the determination is “NO” in step S504, in step S505, the UE 100 initializes the PDCP variable updated in step S502.

When the determination is “YES” in step S504, in step S506, the UE 100 holds the PDCP variable updated in step S502 without initializing the PDCP variable. In other words, the UE 100 again configures the new PDCP entity involved in the re-establishment with the PDCP variable held in the predetermined storage area.

In step S507, the PDCP entity of the UE 100 receives a PDCP packet transmitted from the gNB 200 in the MBS session.

In step S508, the PDCP entity of the UE 100 updates the PDCP variable (e.g., COUNT), based on the PDCP packet received in step S507.

Note that the UE 100 may re-establish the PDCP entity in response to performing the handover from a first cell to a second cell of the gNB 200 or the RRC re-establishment (step S503). When the UE 100 is notified from the gNB 200 that the PDCP variable is continuously usable in the second cell in advance of the handover or the RRC re-establishment performed, the UE 100 may hold the PDCP variable without initializing the PDCP variable even after the handover or the RRC re-establishment performed. Such notification information may be transmitted by the gNB 200 to the UE 100 through the RRC Reconfiguration message or the SIB in the first cell. An operation related to the operation as described above will be described below in Operation Example 6.

### Operation Example 6 of PDCP

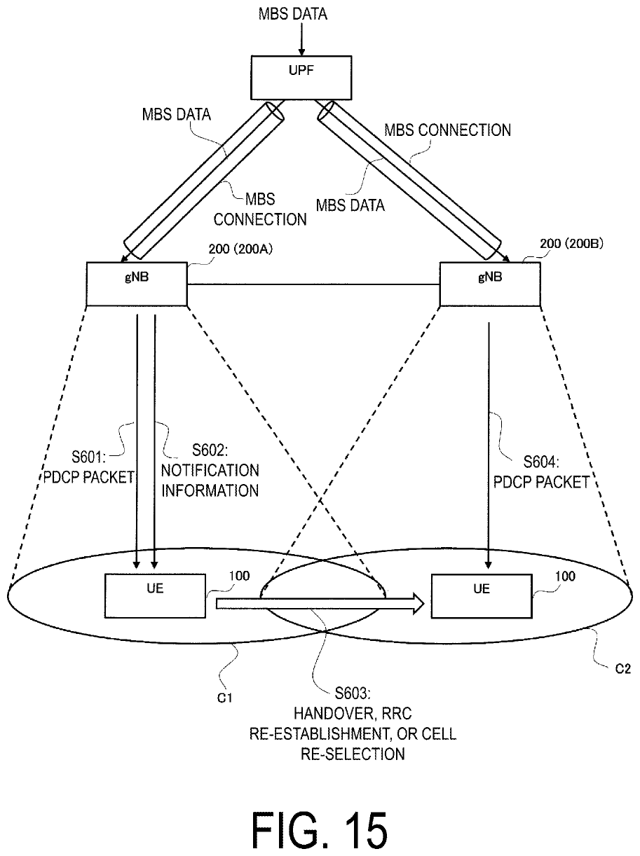

Operation Example 6 of the PDCP according to an embodiment will be described focusing on differences from Operation Examples 1 to 5 described above. FIG. 15 is a diagram for illustrating Operation Example 6 of the PDCP according to an embodiment.

As illustrated in FIG. 15, the UE 100 may perform handover from a cell C1 (first cell) to a cell C2 (second cell), RRC re-establishment, or cell re-selection. FIG. 15 illustrates an example in which a gNB 200A managing the cell C1 is different from a gNB 200B managing the cell C2.

When the MBS session received by the UE 100 in the cell C1 is also provided in the cell C2, the UE 100 can continue the MBS reception even after the handover, RRC re-establishment, or cell re-selection performed. Here, in the cell C1 and the cell C2, even with the PDCP SN synchronized between the cells, the HFN may not be synchronized between the cells. When the HFN is not synchronized between the cell C1 and the cell C2, upon moving from the cell C1 to the cell C2, the UE 100 needs to synchronize with the HFN in the cell C2, that is, the HFN managed by the gNB 200B.

In the present Operation Example 6, firstly, in response to receiving the PDCP packet transmitted in the MBS session, the PDCP entity of the UE 100 updates the PDCP variable (e.g., COUNT) associated with the MBS session (step S601). The PDCP variable to be updated may be RX_NEXT and/or RX_DELIV.

Secondly, in advance of performing the handover from the cell C1 to the cell C2, the RRC re-establishment, or the cell re-selection, the UE 100 receives, from the gNB 200A, notification information indicating whether the updated PDCP variable is continuously usable in the cell C2 (step S602). Note that the gNB 200A is assumed to recognize whether the HFN is synchronized between the cell C1 and the cell C2, through inter-base-station communication with the gNB 200B, for example. When the HFN is synchronized between the cell C1 and the cell C2, the gNB 200A transmits notification information indicating that the updated PDCP variable is continuously usable in the cell C2. On the other hand, when the HFN is not synchronized between the cell C1 and the cell C2, the gNB 200A transmits notification information indicating that the updated PDCP variable is not continuously usable in the cell C2. The gNB 200A may transmit the notification information through the SIB, MCCH, RRC Reconfiguration, or PDCP Control PDU.

The notification information may include information indicating an area including one or more cells where the updated PDCP variable is continuously usable. For example, the notification information may include a cell ID list including cell IDs of cells in which the PDCP variable used in the cell C1 can also be used.

Thirdly, the UE 100 performs the handover from the cell C1 to the cell C2, the RRC re-establishment, or the cell re-selection (step S603). Here, when the notification information indicates that the PDCP variable (e.g., COUNT) used in the cell C1 can also be used in the cell C2, the PDCP entity of the UE 100 continues to use the held PDCP variable in the cell C2 and receives the PDCP packet from the cell C2 (step S604). On the other hand, when the notification information indicates that the PDCP variable used in the cell C1 is not usable in the cell C2, the PDCP entity of the UE 100 derives a PDCP variable from the PDCP packet received first in the cell C2 (see Operation Example 1 described above). Alternatively, when notified, from the gNB 200B, of the HFN being used in the cell C2, the UE 100 may derive a PDCP variable by using the notified HFN.

### Operation Example of RLC

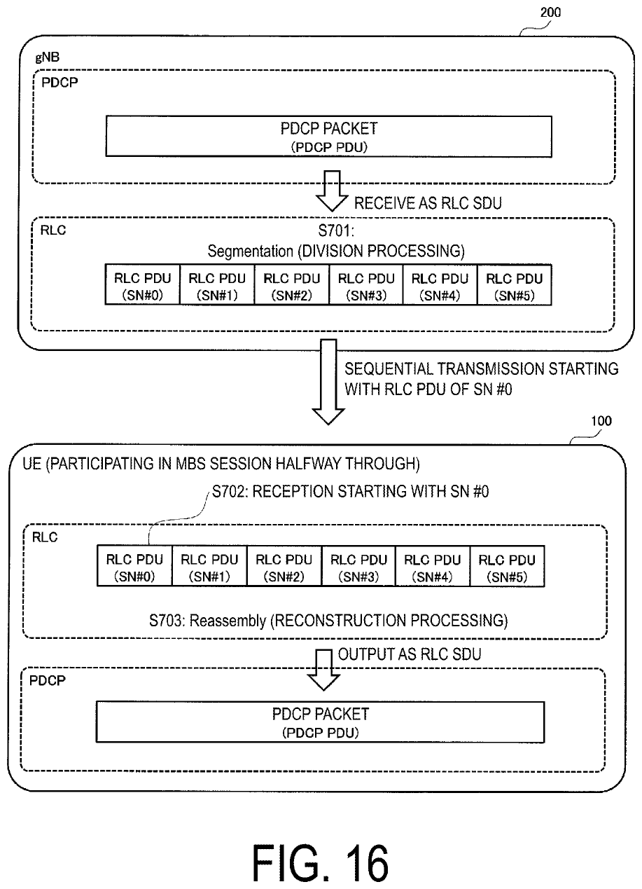

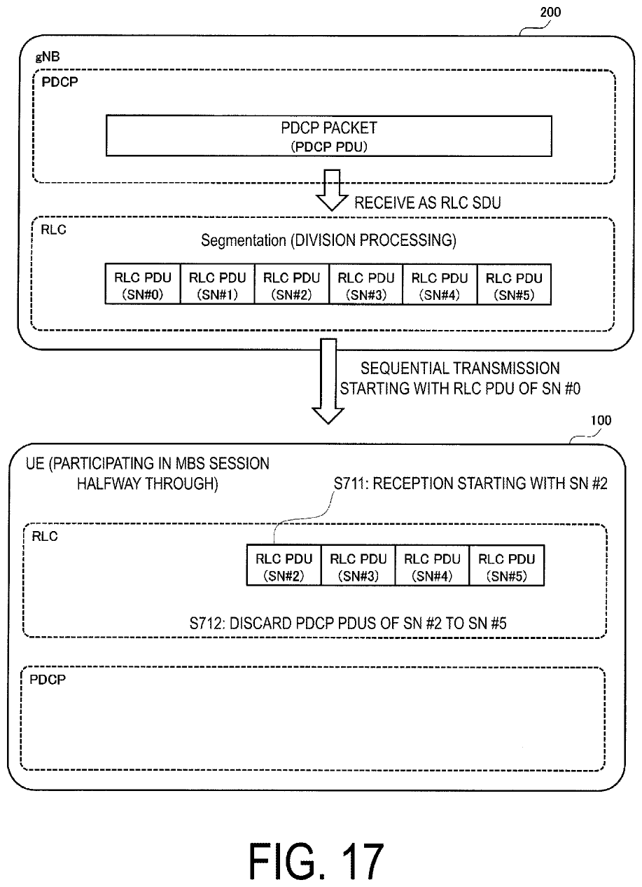

An operation example of RLC according to an embodiment will be described. FIGS. 16 and 17 are diagrams for illustrating an operation example of RLC according to an embodiment. In the present operation example, an RLC entity of the UE 100 receives, from the gNB 200, RLC Protocol Data Units (PDUs) transmitted in an MBS session and obtained by dividing an RLC Service Data Unit (SDU) by the gNB 200.

As illustrated in FIG. 16, in the present operation example, an RLC entity of the gNB 200 is assumed to perform processing of dividing a PDCP packet (i.e., RLC SDU) (step S701). Such division processing may be referred to as Segmentation. The RLC entity of the gNB 200 allocates a sequence number (SN) to each of the segments obtained by the division processing to obtain RLC PDUs. FIG. 16 illustrates an example of segmentation into a total of six RLC PDUs (six segments) with SNs #0 to #5. The RLC entity of the UE 100 needs to receive all of the six RLC PDUs to reconstruct the original PDCP packet (RLC SDU). Such reconstruction processing may be referred to as Reassembly. Note that, in the present operation example, an Unacknowledged Mode (UM) mode is assumed to be applied to the RLC.

In the case of unicast, since the UE 100 starts reception with the first RLC PDU (i.e., the RLC PDU with SN #0), no major problem occurs. On the other hand, in the case of multicast, the UE 100 may participate in the MBS session halfway through and can thus not necessarily start reception with the RLC PDU with SN #0. When the UE 100 fails to receive the RLC PDU with SN #0, the reconstruction of the RLC SDU cannot be completed. RLC SDUs failed to be reconstructed are discarded when the timer (T-Reassembly) expires.

However, when in-order delivery is configured in which PDCP packets (RLC SDUs) are delivered to an upper layer (i.e., PDCP) in order, a problem is that the next PDCP packet cannot be delivered to the upper layer until a timer for reconstruction (T-Reassembly) expires, leading to a delay.

In the present operation example, when the RLC sequence number included in an RLC PDU received first from the gNB 200 is zero, the RLC entity of the UE 100 participating in the MBS session halfway through reconstructs the RLC SDU from the RLC PDU received first and RLC PDUs succeeding the RLC PDU received first. In FIG. 16, the RLC entity of the UE 100 has successfully started reception with the first RLC PDU (i.e., the RLC PDU with SN #0) (step S702). Thus, the RLC entity of the UE 100 reconstructs the RLC SDU (step S703) when the RLC PDUs with SNs #0 to #5 are collected and passes the RLC SDU to the upper layer (i.e., PDCP).

On the other hand, as illustrated in FIG. 17, when the RLC sequence number included in the RLC PDU received first from the gNB 200 is not zero, the RLC entity of the UE 100 discards the first received RLC PDU and RLC PDUs succeeding the first received RLC PDU. In particular, when the RLC sequence number included in the RLC PDU received first from the gNB 200 is not zero, the RLC entity of the UE 100 discards the first received RLC PDU and the RLC PDUs succeeding the first received RLC PDU even when the timer (T-Reassembly) has not expired. As described above, by determining whether to reconstruct the RLC SDU from the first received RLC PDU and the RLC PDUs succeeding the first received RLC PDU based on the RLC sequence number included in the first received RLC PDU from the gNB 200, packets failed to be reconstructed can be discarded early, allowing a possible delay to be suppressed.

In the example illustrated in FIG. 17, the RLC entity of the UE 100 participating in the MBS session halfway through checks the sequence number of the RLC PDU received first from gNB 200 and detects that this sequence number is SN #2 (step S711). In this case, the RLC entity of the UE 100 discards the RLC PDU with SN #2 and the succeeding RLC PDUs with SNs #3 to #5 even when the timer (T-Reassembly) has not expired.

Note that, in the present operation example, in order to minimize discarding of PDCP packets, the gNB 200 desirably reduces the number of RLC segments for the MBS transmission.

### Other Embodiments

Operation Examples 1 to 6 of the PDCP according to the above-described embodiments may be applied to the operation of the RLC. In other words, the “PDCP” in Operation Examples 1 to 6 of the PDCP according to the above-described embodiments may be read as “RLC”.

The operation flows described above can be separately and independently implemented, and also be implemented in combination of two or more of the operation flows. For example, some of the steps in one operation flow may be applied to another operation flow. Some of the steps in one operation flow may be replaced with some of the steps in another operation flow.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processing operations to be performed by the UE 100 or the gNB 200 may be integrated, and at least part of the UE 100 or the gNB 200 may be configured as a semiconductor integrated circuit (a chipset or a System on a chip (SoC)).

Embodiments have been described above in detail with reference to the drawings, but specific configurations are not limited to those described above, and various design variation can be made without departing from the gist of the present disclosure.

### Supplementary Note

### Operation of PDCP

### Initial Values of State Variables

Although the current agreement specifies only the RLC UM mode, for service continuity, it is worth considering how to minimize packet loss at the start of MBS data reception and during dynamic PTM/PTP switching.

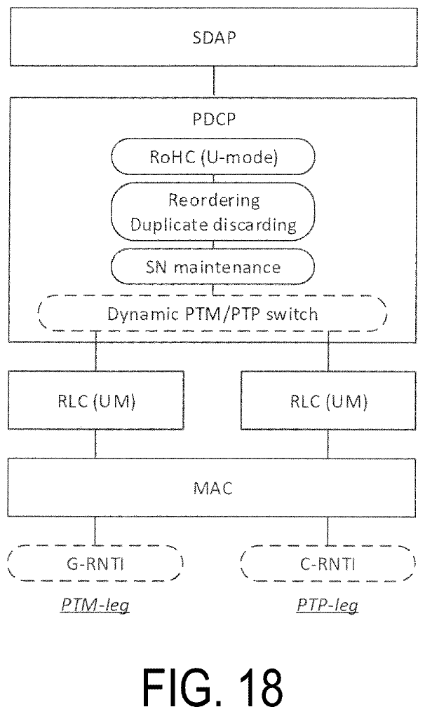

As illustrated in FIG. 18, when an existing PDCP functional view is reused, the PDCP SN is common to both the PTM leg and the PTP leg. The PTM leg is used for a plurality of UEs, and thus the PDCP SN may not be UE-specific and affects both the PTM leg and the PTP leg. This means that, when a UE participates late in a multicast session, the initial value of each state variable is not always “0” regardless of which of the PTM leg and the PTP leg the first received MBS data belongs to. In other words, the PDCP SN received first by the UE can be any value that is not assumed in the current unicast transmission. The state variable is configured with an initial value, and thus PDCP re-establishment of one UE may affect all the other UEs. This causes unexpected behavior in the reception window. In other words, the PDCP PDUs outside the reception window are discarded.

Observation 2: When a UE participates late in a multicast session and the two legs are associated with one MRB, the SN of the first received PDCP PDU is not an initial value, i.e., “0”, regardless of whether the first received data is from the PTM leg or the PTP leg.

To solve this problem, the following options have been proposed.

Option A: The gNB notifies the UE of the initial COUNT value, or RX_NEXT and RX_DELIV.

This option allows the UE to receive the first transmission of MBS data using the existing mechanism simply by changing the initial value associated with the reception window, based on information from the gNB. Note that, from the point of view of the PDCP layer, due to delayed switching, bad radio conditions, or being outside of the RLC re-configuration window, for example, whether the UE can always successfully receive the first transmission intended by the gNB is questionable. In this case, how this option works is unclear.

Option B: The gNB notifies the UE of the first HFN, and the UE infers the first HFN and the SN from the first received PDCP PDU.

With respect to the SN part, this option is similar to the Rel-16 V2X mechanism. In other words, “for broadcast and groupcast NR sidelink communications, the initial value of the SN part of RX_NEXT is (x+1) modulo (2^{[sl-PDCP-SN-Size]}), where x is the SN of the first received PDCP data PDU” and “for broadcast and groupcast NR sidelink communications, the initial value of the SN part of RX_DELIV is (x−0.5×2^{[sl-PDCP-SN-Size-1]}) modulo (2^{[sl-PDCP-SN-Size]}), where x is the SN of the first received PDCP data PDU”.

For the HFN part, the Rel-16 V2X mechanism does not require the transmission device and reception device to be synchronized. In other words, the HFN is not used for security, and thus “Note: It is up to the implementation of the UE to select the HFN for RX_NEXT to make the initial value of RX_DELIV positive”. In the case of an NR MBS, “RAN2 waits for SA3 to finish studying on the security of the MBS and then replies with explaining the security aspect of RAN2”. Therefore, when the HFN part needs to be notified at this point, RAN2 needs to be postponed.

Based on the above-described observations, Option B is to be a baseline for further discussion. According to the broadcast and groupcast Rel-16 sidelink communications, with the progress of SA3 regarding the security of the NR MBS taken into account, RAN2 needs to at least agree on that the UE configures the initial value of the state variable from the first received PDCP PDU of the MBS data.

Proposal 3: RAN2 needs to agree on that the UE configures the initial values of the SN parts of RX_NEXT and RX_DELIV from the first received MBS data regardless of the PTM leg or the PTP leg. Depending on the progress of SA3, whether the HFN part is notified from the gNB needs further studies.

### Simultaneous Reception and UE Assistance Information

When Proposal 2 can be agreed on, the UE needs to support simultaneous reception from both the PTM leg and the PTP leg. In other words, the two legs can be activated simultaneously as in the case with replication of an existing PDCP packet. The PTP leg is received by a plurality of UEs, that is, the PTP leg is not UE-specific, and thus missing packets not received via the PTM leg can be easily compensated for. This is considered to be beneficial for dynamic PTM/PTP switching. Therefore, RAN2 needs to agree on simultaneous reception for at least a certain period of time in dynamic PTM/PTP switching.

Proposal 4: RAN2 needs to agree on that the UE supports simultaneous reception from both PTM and PTP legs for a certain period of time after the dynamic PTM/PTP switching. When Proposal 3 and Proposal 4 can be agreed on, the gNB may not actually be aware of the PDCP SN with which the UE has successfully started reception via the PTM leg. This means that, in the case of switching from PTP to PTM, the gNB may not be aware of which PDCP PDU needs to be transmitted via the PTP leg and/or when the PTP leg can be deactivated. To solve this problem, a proposed has been made that the UE notifies the gNB that PTM reception is successful. This can be transmitted via the PTP leg when the PTP leg is not deactivated yet. Note that, whether this solution intends to include the PDCP SN in the information is not clear.

Similarly, in the case of switching from PTM to PTP, the gNB may not be aware of the PDCP SN with which the UE has finished reception via the PTM leg. This means that the gNB may not be aware of the PDCP PDU with which the gNB starts transmission via the PTP leg. Therefore, the UE may be considered to notify the gNB of the SN information via the activated PTP leg during dynamic PTM/PTP switching.

When the UE reports the SN information during dynamic switching between PTM and PTP, reuse of the PDCP control PDU is straightforward, and to be exact, the PDCP status report includes the FMC (the first missing PDCP SDU) and any bitmap (indicating that the next PDCP SDU is missing or has been correctly received). On the other hand, reporting the first/last successful PDCP SDU reception via the PTM leg is another option. Therefore, what needs to be reported during dynamic switching between PTM and PTP needs to be further discussed.

In any of the above-described cases (i.e., PTP to PTM and PTM to PTP), the PDCP control PDU needs to be triggered upon dynamic switching (e.g., by an activation/deactivation MAC CE) including PDCP SN information for service continuity.

Proposal 5: RAN2 needs to consider, for the service continuity, whether the UE transmits the PDCP control PDU including the PDCP SN information during dynamic switching. Further studies are required for the type of the PDCP control PDU to be used and the exact meaning of the SN information.

### REFERENCE SIGNS

10: NG-RAN (5G RAN)
20: 5GC (5G CN)
100: UE
110: Receiver
120: Transmitter
130: Controller
200: gNB
210: Transmitter
220: Receiver
230: Controller
240: Backhaul communicator

1. A communication control method performed by a user equipment in a mobile communication system for providing a multicast broadcast service (MBS) from a base station to the user equipment, the communication control method comprising:
receiving, from the base station, an RRC message including an initial value of a PDCP variable for a multicast service; and
setting the initial value of the PDCP variable included in the RRC message, wherein
the PDCP variable is a variable used for reception window control and indicates a count value of a PDCP SDU awaiting being received and not yet provided to an upper layer, and
the count value is composed of a PDCP sequence number and a hyper frame number.

2. The communication control method according to claim 1, further comprising
receiving, from the base station, the hyper frame number.

3. The communication control method according to claim 1, further comprising
receiving, from the base station, an RRC message including an initialization instruction instructing initialization of the PDCP variable for the multicast service, wherein
the initialization instruction is an instruction for re-establishing a PDCP entity.
